(19) United States
(12) Patent Application Publication
(10) Pub. No.: US 2012/0172196 A1
(43) Pub. Date: Jul. 5, 2012

(54) PHOTOCATALYTIC MULTILAYER METAL COMPOUND THIN FILM AND METHOD FOR PRODUCING SAME

(76) Inventors: Daisuke Noguchi, Miyakonojo-City (JP); Yoshihiko Kawano, Miyazaki-City (JP); Fumihiro Sei, Miyazaki-City (JP)

(21) Appl. No.: 13/391,564

(22) PCT Filed: Aug. 23, 2010
(86) PCT No.: PCT/JP2010/064201

§ 371 Date: Mar. 22, 2012

(30) Foreign Application Priority Data
Aug. 24, 2009 (JP) 2009-193027

(51) Int. Cl. B01J 37/34; B01J 21/06; B82Y 30/00

(52) U.S. Cl. 502/5; 502/350; 502/242; 977/755; 977/902

(57) ABSTRACT

To provide a photocatalytic titanium oxide film having high photocatalytic properties, at low temperatures, quickly, and inexpensively, a seed layer comprising a noncrystalline metal compound film is formed on the surface of a base, which is made from glass, plastic or the like, and a crystalline metal compound film is formed by columnar growth on the seed layer; in producing this film, the photocatalytic titanium oxide film is produced by way of sputtering, at low cost, by way of low temperature and high speed film formation, without pre-processing with a plasma of an active gas, without post-processing, and without heat treatment.

### BACKGROUND OF THE INVENTION

The present invention relates to a photocatalytic metal compound film, and more particularly relates to a photocatalytic multilayer metal compound film having a crystalline structure, which can be formed rapidly under low temperature conditions, and to a method for producing the same.

Titanium oxide films have photocatalytic functions, exhibiting excellent functions such as antimicrobial functions, anti-odor functions, anti-soiling functions, and hydrophilic functions; in particular, hydrophilic films are widely used for automobile side mirrors, mirrors installed on roadways, building materials for the outer walls of buildings and the like.

When this titanium oxide is used as a photocatalytic material, it is usually necessary to use it fixed on the surface of a substrate of some sort, in the form of a film, and therefore sputtering techniques are used to strongly adhere this to the surface of various substrates. In terms of conventional sputtering techniques, the most commonly adopted is reactive sputtering, in which a titanium metal target is used, argon gas and oxygen gas are introduced, and the titanium oxide film is formed; but with this film formation technique, the film formation rate was slow, at approximately 10 nm/minute, and pre-processing or post-processing heat treatment of the substrate was necessary to bring about the photocatalytic function. Furthermore, while it is also possible to form titanium oxide films that exhibit photocatalytic functions at low temperatures, the speed is extremely slow, and thus use in industry has not been possible.

Here, a technique for preparing hydrophilic films has been proposed consisting of: a sputtering step wherein, in a film forming process region within a vacuum vessel, a target comprising at least one type of metal is sputtered onto a base, so as to lay down a film starting material made from the metal, on the surface of the base; a step of transporting the base into a reaction process region that is formed at position separated from the film forming process region; and, with at least one type of reactive gas introduced into the reaction process region, generating a plasma of the reactive gas so as to react the reactive gas with the film starting material, and thus generate a compound or an incomplete compound of the reactive gas and the film starting material (see Japanese Laid-Open Patent Application JP-2007-314835-A).

Other prior art is MOCHIZUKI, Shohei, SAKAI, Tetsuya, ISHIHARA Taiju, SATO, Noriyuki, KOBAYASHI, Koji, MAEDA, Takeshi, HOSHI, Yoichi, “Film Thickness Dependency of TiO₂ Film Produced by Oxygen Ion Assisted Reactive Vapor Deposition,” 69th Conference of the Japan Society of Applied Physics, 3a-J-8 (September 2008)

### SUMMARY OF THE INVENTION

However, with the technique for preparing a hydrophilic film described in the aforementioned patent document, there was a problem in so much as it was necessary to perform plasma processing with a plasma of the reactive gas before or after forming the hydrophilic film at least on the surface of the base, and thus the base was heated for a long period of time by the plasma energy, and therefore it was not possible to form a photocatalytic film at low temperatures (100° C. or less). Furthermore, it was necessary that the thickness of the hydrophilic film be no less than 240 nm, which was expensive.

The present invention is a reflection of the problems described above, and provides a photocatalytic multilayer metal compound film having high photocatalytic properties and a method for producing the same, at low temperatures (100° C. or less), at high speeds, and inexpensively, without pre-processing such as plasma processing being performed on the surface of the base, without post-processing after forming the hydrophilic film, and without heat treatment.

Thus, a first characteristic of the photocatalytic multilayer metal compound film of the present invention is that of comprising: a seed layer comprising a noncrystalline metal compound film formed on the surface of a base; and a crystalline metal compound film formed by columnar growth on the seed layer.

Furthermore, a second characteristic is that the total thickness of the seed layer, consisting of a noncrystalline metal compound film formed on the surface of the base and the crystalline metal compound film formed on the seed layer is no less than 100 nm.

Next, a third characteristic is that a silicon oxide film is further disposed between the base and the seed layer.

Moreover, a fourth characteristic is that the method of producing a photocatalytic multilayer metal compound film is such that a seed layer comprising a noncrystalline metal compound film is formed on the surface of a base by repeating a process of depositing an ultrathin film of a metal compound by sputtering, and then bombarding with activated species of a noble gas and a reactive gas; and a crystalline metal compound film grown in a columnar manner on the seed layer is formed by repeating a process of depositing an ultrathin film comprising metal and incomplete reaction products of metal on the seed layer by sputtering, and then bombarding with activated species of a noble gas and a reactive gas.

In addition, a fifth characteristic is that the noncrystalline metal compound film and the crystalline metal compound film are formed from titanium oxide. Note that, glass substrates, ceramic substrates and plastic substrates can effectively be used as the base.

By virtue of the photocatalytic multilayer metal compound film and the method of preparing the same according to the present invention, because the base is not subjected to heat treatment or plasma processing with reactive gas, an excellent effect is provided wherein a photocatalytic film can be formed having high photocatalytic properties, resulting from low temperatures.

Furthermore, the total thickness of the noncrystalline metal compound film seed layer, which is formed on the surface of the base, and the crystalline metal compound film, which is formed on the seed layer, is no less than 100 nm, which is less than half the film thickness of conventional photocatalytic films, whereby the properties of hydrophilicity and oil decomposition can be achieved in a short period of time, and the film can be formed rapidly, which has the excellent advantage of being inexpensive.

### BRIEF DESCRIPTION OF THE DRAWINGS

FIG. 1 is a schematic view illustrating a device for forming the photocatalytic multilayer metal compound film of the present invention.

FIGS. 2(a) and 2(b) are schematic sectional views illustrating an embodiment of the photocatalytic multilayer metal compound film of the present invention.

FIG. 3 is a flowchart showing the steps for producing the photocatalytic multilayer metal film according to a first mode of embodiment of the present invention.

FIG. 4 is a flowchart showing the steps for producing the photocatalytic multilayer metal film according to a second mode of embodiment of the present invention.

FIG. 5 is a photograph showing a TiO₂ film in the Working Example.

FIG. 6 is a photograph showing a TiO₂ film in Comparative Example 1.

FIG. 7 is a photograph showing differences in the crystal structure of the photocatalytic multilayer metal compound film according to the present invention.

FIG. 8 is a graph indicating the photocatalytic properties of the photocatalytic multilayer metal compound film according to the present invention.

FIG. 9 is a graph indicating the photocatalytic properties of the photocatalytic multilayer metal compound film according to the present invention.

### DETAILED DESCRIPTION OF THE INVENTION

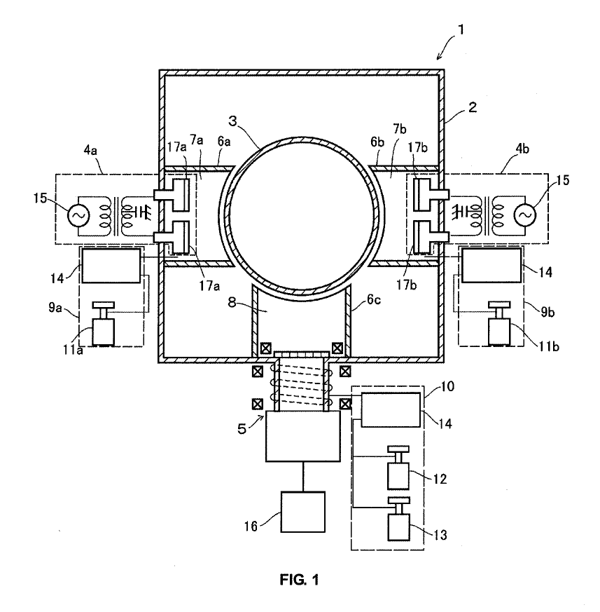

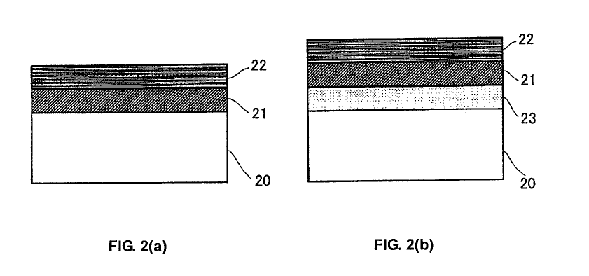

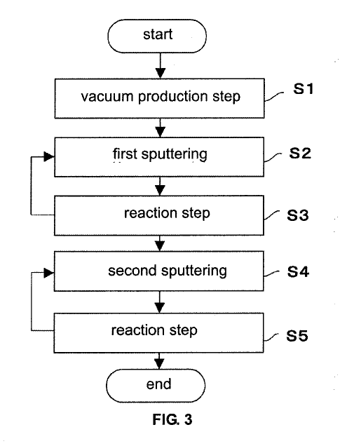

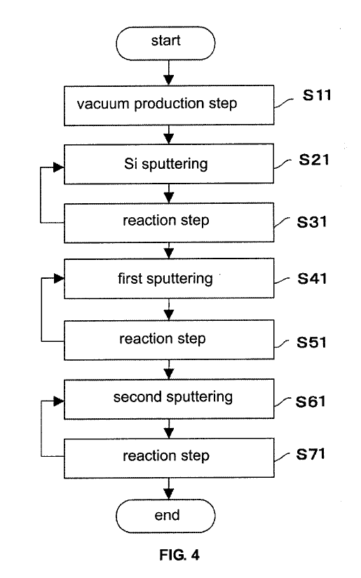

Hereafter, the best mode for carrying out the present invention is described based on the working example shown in the drawings, but it is a matter of course that the present invention is not limited to this working example. FIG. 1 is a schematic view, seen from above, of a device for forming the photocatalytic multilayer metal compound film of the present invention; FIG. 2 is a schematic sectional view of a mode of embodiment of the photocatalytic multilayer metal compound film of the present invention; FIG. 3 is a flowchart showing the steps for producing the photocatalytic multilayer metal compound film according to a first mode of embodiment of the present invention; and FIG. 4 is a flowchart showing the steps for producing a photocatalytic multilayer metal compound film according to a second mode of embodiment.

In the Working Example, a description is given of an example using magnetron sputtering devices, employing two types of metal targets, as the sputtering devices, but other sputtering devices may also be used. Furthermore, metallic titanium was used as the metal employed for the photocatalytic multilayer metal compound film.

FIG. 1 shows a sputtering device 1 for forming the photocatalytic multilayer metal compound film of the present invention. In the figure, a rotary drum 3 is rotatably provided in the center of a vacuum vessel 2, and a plurality of bases, which are described hereafter, are mounted around this rotary drum 3. Furthermore, two sets of sputtering means 4a, 4b and an active species generation device 5 are arranged around the rotary drum 3, which are separated, spaced apart at predetermined intervals, by respective dividing walls 6a, 6b, 6c.

Film forming process regions 7a, 7b are formed between the sputtering means 4a, 4b and the rotary drum 3, which faces these; a reaction process region 8 is formed between the active species generation device 5 and the rotary drum 3; sputtering gas supply means 9a, 9b and a reactive gas supply means 10 are provided in these regions.

A plurality of bases made from glass, plastic and the like are mounted on the external circumferential face of the rotary drum 3, and rotated by a motor (not shown), so as to repeatedly travel between the film forming process regions 7a, 7b and the reaction process region 8, and thus repetitively undergo sputter processing in the film forming process regions 7a, 7b and reaction processing in the reaction process region 8, whereby films are formed on the surfaces of the bases.

Furthermore, argon gas canisters 11a, 11b, for the sputtering gas, are provided in the sputtering gas supply means 9a, 9b, and an oxygen gas canister 12, for the reactive gas, and an argon gas canister 13 are provided in the reactive gas supply means 10, the supplies thereof being regulated by gas flow regulators 14.

The sputtering device 1 in this mode of embodiment, which is configured as described above, is characterized in that, while the film forming process regions 7a, 7b and the reaction process region 8 are positioned separated within the same vacuum vessel 2, they are formed so as to allow gas-flow communication in accordance with the regulation of the gas supply by way of the gas flow regulators 14; specifically, as a result of setting the supply of oxygen gas and argon gas, which are supplied to the reaction process region 8, so as to be greater than the supply of argon gas, which is supplied to the film forming process regions 7a, 7b, oxygen gas can be supplied by way of passing over the dividing walls 6a, 6b, 6c, making it possible to perform sputtering with reactive sputtering.

Next, a method of forming the photocatalytic multilayer metal compound film of the present invention is described based on FIG. 2 through FIG. 4.

FIG. 2a shows a mode of embodiment in which, by way of the method of forming the photocatalytic multilayer metal compound film of the present invention, a photocatalytic film comprising two titanium oxide films 21, 22 has been formed on a glass substrate 20; and FIG. 2b shows a mode of embodiment in which a silicon oxide film 23 has been formed between the glass base 20 and the two photocatalytic films 21, 22. Note that the titanium oxide film 21 is a noncrystalline titanium oxide film, and the titanium oxide film 22 is a crystalline titanium oxide film, the total thickness thereof being no less than 100 nm. In the following, the steps in the mode of embodiment mentioned above are described in accordance with FIG. 3 and FIG. 4.

### First Mode of Embodiment

First, glass substrates 20 are set on the rotary drum 3 in the vacuum vessel 2, and a high vacuum is created within the vacuum vessel 2, by way of a vacuum pump (not shown) (step S1).

Next, with argon gas introduced into the film forming process regions 7a, 7b from the sputtering gas supply means 9a, 9b, and argon gas and oxygen gas introduced into the reaction process region 8 from the reactive gas supply means 10, power is supplied from an AC power supply 15 to sputtering electrodes in the film forming process region 7a, an AC voltage is applied to the active species generation device 5, from a high frequency power supply 16, and the rotary drum 3 is rotated counterclockwise. At this point, the flows of argon gas introduced into the film forming process regions 7a, 7b are both set to less than the flow of argon gas and oxygen gas introduced into the reaction process region 8, allowing oxygen gas to flow from the reaction process region 8 to the film forming process regions 7a, 7b. Note that all of these settings are regulated by the gas flow regulators 14.

In this step, metallic titanium has been mounted in the film forming process region 7a in the form of targets 17a and, in the film forming process region 7a, ultrathin films comprising a metallic titanium compound are formed on the surfaces of the glass substrates 20 that are set on the rotary drum 3 (step S2).

Then, when the glass substrates 20 that are set on the rotary drum 3 move to the reaction process region 8, the ultrathin film made from the metallic titanium compound is formed into a noncrystalline titanium oxide film 22 by way of the active species generation device 5 and the oxygen gas and argon gas (step S3).

The steps S2 and S3 are repeatedly performed as a result of the rotation of the rotary drum 3, so that a noncrystalline titanium oxide film having a desired thickness is formed. Note that the thickness of the noncrystalline titanium oxide film should be at least 5 nm.

Next, the flow of the argon gas that is introduced into the film forming process regions 7a, 7b and the flow of the argon gas and oxygen gas that are introduced into the reaction process region 8 are regulated by the gas flow regulators 14, so as to produce a state in which oxygen gas is prevented from flowing from the reaction process region 8 to the film forming process regions 7a, 7b, power is supplied to the sputtering electrodes in the film forming process region 7a from the AC power supply 15, and AC voltage is applied to the active species generation device 5 from the high-frequency power supply 16.

In this step, in the film forming process regions 7a, an ultrathin film comprising metallic titanium and the incomplete reaction product of metallic titanium is formed on the noncrystalline metallic titanium compound film, on the surface of the glass substrates 20 that are set on the rotary drum 3 (step S4).

Then, when the glass substrates 20 that are set on the rotary drum 3 move to the reaction process region 8, while oxygen gas and argon gas are supplied from the active species generation device 5, the ultrathin film comprising the metallic titanium and the incomplete reaction product of the metallic titanium is formed into a crystalline titanium oxide film (step S5).

The steps S4 and S5 are repeatedly performed as a result of the rotation of the rotary drum 3, so as to form a film having a desired thickness, thus forming a photocatalytic titanium oxide film, which is the photocatalytic multilayer metal compound film of the present invention.

### Second Mode of Embodiment

Next, referring to FIG. 4, the second mode of embodiment will be described. Note that, steps S41 to S71 in the figure are the same as steps S2 to S5 described above, and description thereof is omitted.

First, in the same manner as in the first mode of embodiment, the glass substrates 20 are set on the rotary drum 3 in the vacuum vessel 2, and a high vacuum is created within the vacuum vessel 2, by way of a vacuum pump not shown (step S11).

Next, with argon gas introduced into the film forming process regions 7a, 7b from the sputtering gas supply means 9a, 9b, and oxygen gas introduced into the reaction process region 8 from the reactive gas supply means 10, power is supplied from an AC power supply 15 to the sputtering electrodes in the film forming process region 7a, an AC voltage is applied to the active species generation device 5, from a high frequency power supply 16, and the rotary drum 3 is rotated. At this time, the flows of argon gas that is introduced to the film forming process regions 7a, 7b are both set to greater than the flow of oxygen gas that is introduced into the reaction process region 8, so that oxygen gas cannot flow from the reaction process region 8 to the film forming process regions 7a, 7b.

In this step, silicon is mounted as the target 17b in the film forming process region 7b, and a silicon film is formed on the surface of the glass substrates 20 that are set on the rotary drum 3, in the film forming process region 7b (step S21).

Next, when the glass substrates 20 that are set on the rotary drum 3 move to the reaction process region 8, while the oxygen gas is supplied by the active species generation device 5, the Si film is formed into a SiO₂ film (step S31).

The steps S21 and S31 are repeated as a result of the rotation of the rotary drum 3, so as to form a SiO₂ film of a desired thickness (for example, 100 nm). Furthermore, the desired photocatalytic titanium oxide film is formed on the SiO₂ film by way of steps S41 to S71, so as to form a photocatalytic titanium oxide film, which is the multilayer metal compound film of the present invention. Note that it is a matter of course that a SiO₂ film may be formed on this photocatalytic titanium oxide film as a protective film, which is hydrophilic and has the effect of maintaining darkness.

### Working Example

Next, a working example is described in which a photocatalytic multilayer metal compound film was actually formed by way of the method of producing a photocatalytic multilayer metal compound film of the present invention. Note that this working example corresponds to the second mode of embodiment described above.

Using the sputtering device shown in FIG. 1, a multilayer metal compound film comprising silicon oxide and titanium oxide was formed on the surface of a glass substrate 20. This was performed by way of the work steps shown in FIG. 4. Note that the various conditions in each of the steps were as shown below.

(Conditions for Forming the SiO₂ Film)
Power applied to target: 6.5 kW
Power applied to the active species generation device 5: 3.5 kW
Total pressure within the sputtering device: 0.34 Pa
Rotational speed of the rotary drum 3: 100 rpm
Film formation time: 249.7 seconds

(Conditions for Forming the Seed Layer TiO₂)
Power applied to target: 3.8 kW
Power applied to the active species generation device 5: 3.0 kW
Total pressure within the sputtering device: 0.74 Pa
Rotational speed of the rotary drum 3: 100 rpm
Film formation time: 370.3 seconds

(Conditions for Forming the Photocatalytic Layer TiO₂ Film)
Power applied to target: 3.0 kW
Power applied to the active species generation device 5: 3.0 kW
Total pressure within the sputtering device: 0.57 Pa
Rotational speed of the rotary drum 3: 100 rpm
Film formation time: 406.2 seconds

### Comparative Example 1

Using the sputtering device shown in FIG. 1, a metal compound film comprising silicon oxide and titanium oxide was formed on the surface of a glass substrate 20. The work steps in the Working Example described above were performed, with the exception of the formation of the inner seed layer TiO₂ film, and the film thickness of the metal compound film was the same as in the Working Example.

### Comparative Example 2

Using the sputtering device shown in FIG. 1, a metal compound film comprising titanium oxide was formed on the surface of a glass substrate 20. A SiO₂ film was formed on a titanium oxide film, by way of carrying out working steps in accordance with the conventional method set forth in the aforementioned Patent Document 1. The film thickness of the resulting metal compound film was 240 nm. Note that plasma processing was performed in order to render this titanium oxide film photocatalytic.

### (Comparison of Titanium Oxide Films)

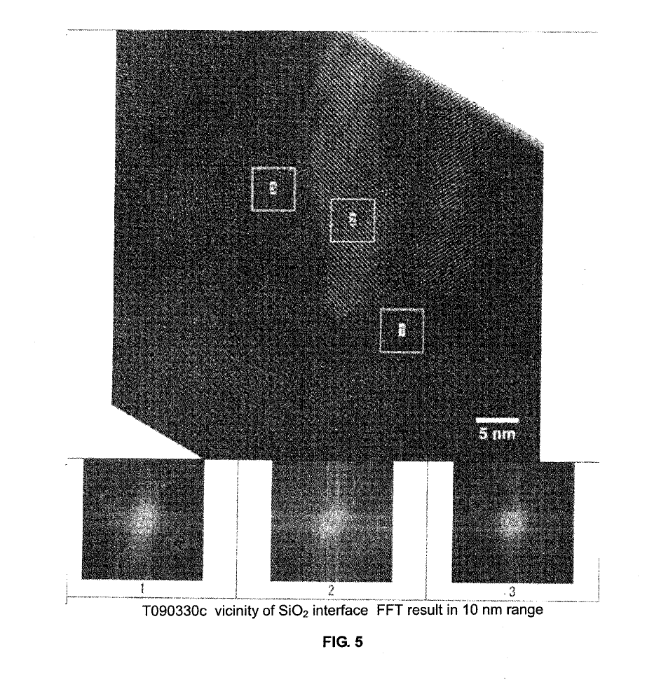

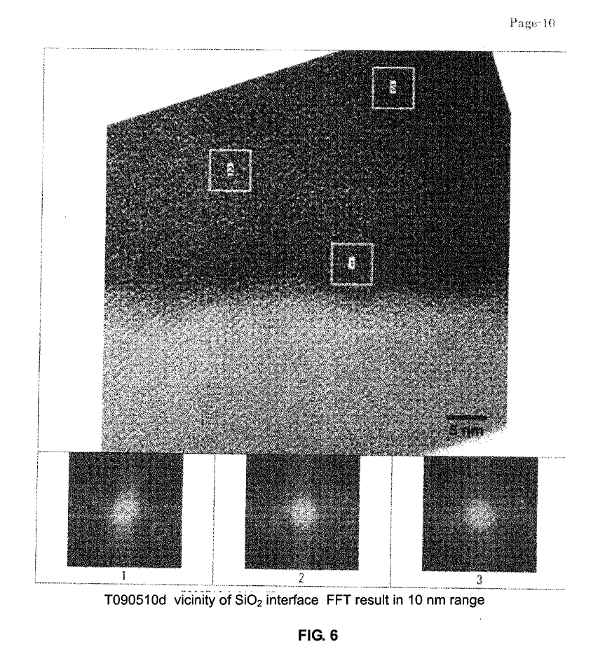

The results of observing the SiO₂/TiO₂ layers formed on the glass substrates at the sectional face, with a transmission electron microscope (JEM-4000 EM, made by JEOL Ltd.) are shown in FIG. 5 and FIG. 6. In terms of the layers in the Working Example, a two-layer structure was observed, wherein a 5 to 7 nm amorphous TiO₂ layer was observed at the interface with the SiO₂ with a columnar crystallized TiO₂ layer directly thereabove, extending to the topmost surface. Furthermore, in terms of the layers in Comparative Example 1, an amorphous layer was observed extending to approximately 25 nm from the interface with the SiO₂, and crystallized regions were observed to be locally present within an amorphous and microcrystalline layer extending to the topmost surface. Note that the total film thickness of the two TiO₂ films in the Working Example was 125 nm. Note that FIG. 5 shows the TiO₂ film of the Working Example and FIG. 6 shows the TiO₂ film of the Comparative Example 1.

### (Comparison of Crystal Structures)

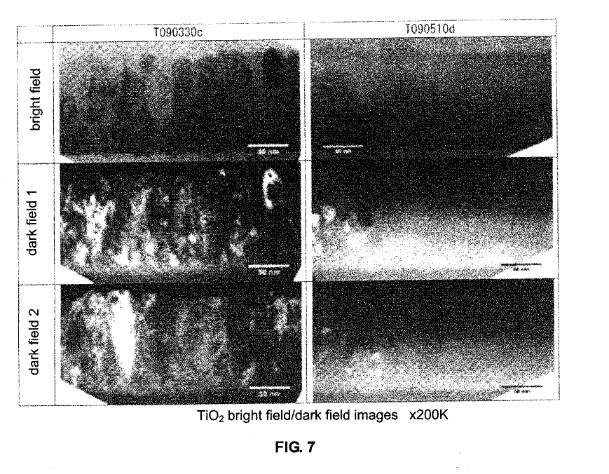

Upon comparing d-values found from the electron diffraction patterns for the TiO₂ layer in the Working Example and the TiO₂ layer in Comparative Example 1, and the x-ray diffraction d-values, it was found that anatase-type structures could be seen in both. Furthermore, FIG. 7 shows dark field images with the same observation positions as TiO₂ bright fields using cross-sectional TEM, and as made clear by the Working Example and Comparative Example 1, it was confirmed that, with the photocatalytic multilayer metal compound film of the present invention wherein the seed layer was formed, a TiO₂ film was formed, crystallized in a columnar manner, starting from the interface with the amorphous TiO₂ layer, and the crystalline characteristics were superior to that of Comparative Example 1. Note that, in FIG. 7, T090330c designates the TiO₂ film of the Working Example and T090510d designates the TiO₂ film of Comparative Example 1, and the same photographic positions were measured for the dark fields 1 and 2.

### (Comparison of Photocatalytic Properties 1)

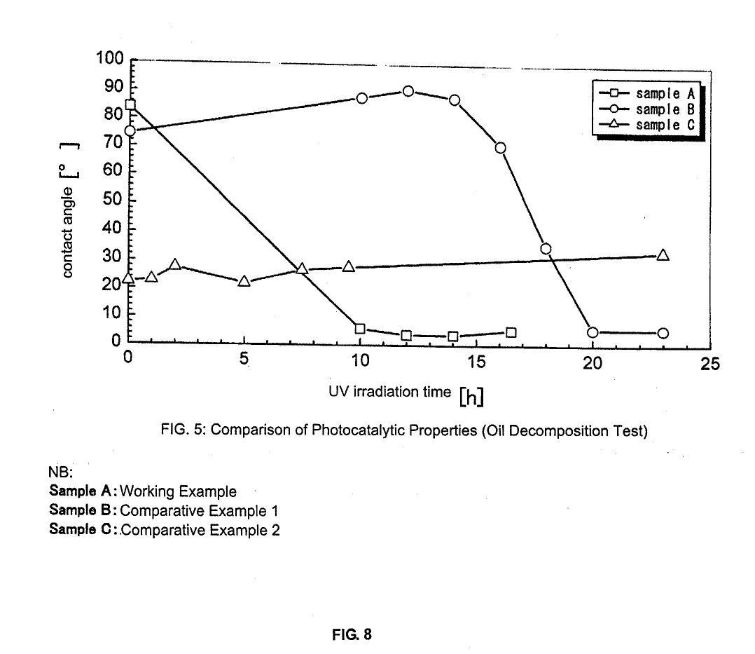

The photocatalytic properties of the three types of photocatalytic films described above were compared by way of an oil decomposition evaluation method. This oil decomposition evaluation method was one wherein: a substrate on which a photocatalytic film that had been formed was irradiated with ultraviolet light (peak wavelength: 350 nm) for 24 hours; a fixed quantity of pure water was applied dropwise, and the contact angle was measured using a contact angle measurement device; then after applying oil dropwise onto the base from which the pure water had been dried and spreading this out on the entire face, this was irradiated with ultraviolet light (peak wavelength 350 nm) for 10 hours; pure water was applied dropwise, and the contact angle was once again measured with the contact angle measurement device. FIG. 8 shows the results of comparing photocatalytic properties subsequent to the dropwise application of oil described above.

As shown in FIG. 8, with the photocatalytic film in which a seed TiO₂ layer was formed in the Working Example, the contact angle was less than 10° at 10 hours of ultraviolet irradiation, and thus it was determined that photocatalytic properties that were much higher than those in Comparative Examples 1 and 2 were rapidly demonstrated. Furthermore, while photocatalytic properties were demonstrated in Comparative Example 1 with low temperature (no greater than 100° C.) photocatalytic film formation conditions, it was made clear that high photocatalytic properties were not demonstrated.

### (Comparison of Photocatalytic Properties 2)

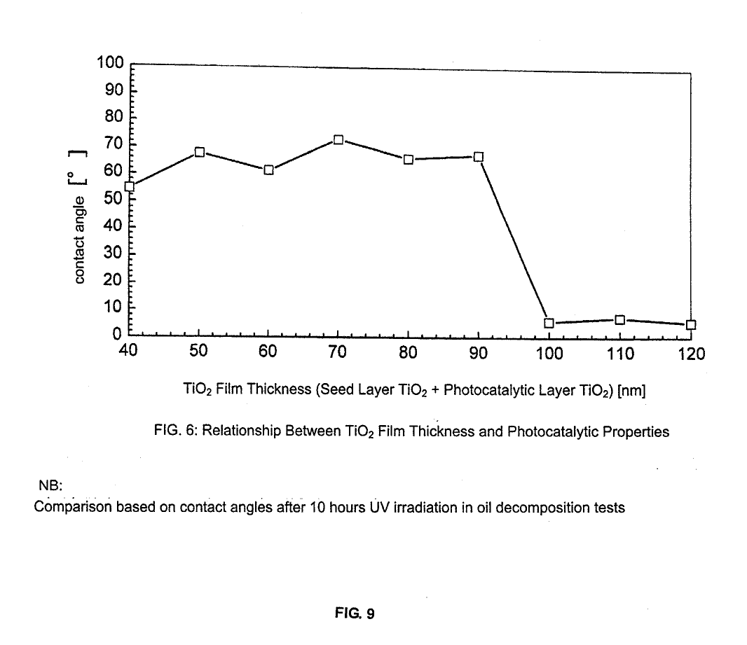

The photocatalytic film of the present invention was evaluated using the oil decomposition evaluation method described above, with substrates prepared so that the TiO₂ film thickness was varied stepwise from 40 nm to 120 nm. The results are shown in FIG. 9.

As shown in FIG. 9, in comparing the contact angle after 10 hours of ultraviolet irradiation, it was determined that excellent photocatalytic properties were demonstrated at greater than 100 nm. It can be observed that photocatalytic properties are dependent on the film thickness of the TiO₂ and, generally, photocatalytic properties improve with increases in film thickness, while photocatalytic properties decrease with decreases in film thickness (see Non-Patent Document 1); with Comparative Example 1, photocatalytic properties were demonstrated at a film thickness of 125 nm, but it may be considered that high photocatalytic properties are not demonstrated at a film thickness on the order of 100 nm.

As described above, the photocatalytic multilayer metal compound film and the method for producing the same of the present invention allow photocatalytic films to be formed having high photocatalytic properties, resulting from low temperatures, because heat treatment and plasma processing of the base with reactive gas and the like are not performed. Accordingly, film formation is possible even with resin bases. Moreover, it suffices that the total film thickness of the noncrystalline metal compound film seed layer formed on the surface of the base and the crystalline metal compound film formed on the seed layer be no less than 100 nm, which is a film thickness of less than half of conventional photocatalytic films, with which hydrophilicity and oil decomposition properties can be achieved in a short period of time, and film formation can be performed rapidly and at low cost.

1. A photocatalytic multilayer metal compound film comprising: a seed layer comprising a noncrystalline metal compound film formed on the surface of a base; and a crystalline metal compound film formed by columnar growth on the seed layer.

2. The photocatalytic multilayer metal compound film according to claim 1, wherein total thickness of the seed layer on the surface of the base and the metal compound film formed by columnar growth on the seed layer is no less than 100 nm.

3. The photocatalytic multilayer metal compound film according to claim 1, further comprising a silicon oxide film disposed between the base and the seed layer.

4. The photocatalytic multilayer metal compound film according to claim 1, wherein the noncrystalline metal compound film and the crystalline metal compound film are formed from titanium oxide.

5. A method of producing a photocatalytic multilayer metal compound film, comprising forming a seed layer comprising a noncrystalline metal compound film on a surface of a base by repeating a process of depositing an ultrathin film of a metal compound by sputtering, and then bombarding with activated species of a noble gas and a reactive gas; and forming a crystalline metal compound film grown in a columnar manner on the seed layer by repeating a process of depositing an ultrathin film comprising metal and incomplete reaction products of metal on the seed layer by sputtering, and then bombarding with activated species of a noble gas and a reactive gas.

6. The method of producing a photocatalytic multilayer metal compound film according to claim 5, wherein the noncrystalline metal compound film and the crystalline metal compound film are titanium oxide.
